(19) United States
(12) Patent Application Publication
(10) Pub. No.: US 2015/0247604 A1
(43) Pub. Date: Sep. 3, 2015

(54) SPLINED SHAFT COUPLING ARRANGEMENT

(71) Applicant: DEERE & COMPANY, Moline, IL (US)

(72) Inventors: Kyle K. McKinzie, Altamont, KS (US); Galen R. Love, Cherryvale, KS (US)

(73) Assignee: DEERE & COMPANY, Moline, IL (US)

(21) Appl. No.: 14/195,305

(22) Filed: Mar. 3, 2014

(51) Int. Cl. F16N 27/00; F16J 15/02; F16D 1/10

(52) U.S. Cl. CPC F16N 27/005; F16D 1/101; F16J 15/02

(57) ABSTRACT

The disclosure provides an improved splined shaft coupling including an inner shaft having at least one external spline and an outer shaft having an internal cavity configured to receive and mate with the inner shaft at a connection interface and having at least one internal spline configured to engage the external spline(s) at a shaft coupling. At least one of the inner and outer shafts has a channel positioned at the connection interface. A seal is disposed in the channel. The seal has at least one fluid passage configured to meter a fluid at a defined rate to the spline coupling.

### CROSS-REFERENCE TO RELATED APPLICATION(S)

Not Applicable.

### STATEMENT REGARDING FEDERALLY SPONSORED RESEARCH

Not Applicable.

### FIELD OF THE DISCLOSURE

This disclosure relates to splined shaft connections, and more particularly to a system and method for providing a seal between splined shafts for improved lubrication.

### BACKGROUND OF THE DISCLOSURE

It is often difficult to provide lubrication between two shafts that transfer torque from one to another via one or more spline couplings. For improved spline life, lubricant can be flushed between the splines. For efficient use of lubricant, the amount of lubricant flushed through the splines should be metered and/or controlled. Whereas there may be multiple ways to provide lubricant to a spline coupling, it is difficult to reliably accomplish the task without the addition of extra machining steps that increase manufacturing costs associated with the manufacture of the shaft(s).

### SUMMARY OF THE DISCLOSURE

According to the present disclosure, there is provided an improved splined shaft coupling and seal arrangement for lubrication of the splined connection. In particular, by controlling the configuration and fit of the seal at the interface of the mating shafts, the amount of lubricant able to pass across the seal to the spline coupling can be effectively metered.

One aspect of the disclosure is a splined shaft assembly having an inner shaft and an outer shaft coupled together at a connection interface. The inner shaft has at least one external spline at an outer surface, and the outer shaft has an internal cavity configured to receive and mate with the inner shaft and having at least one internal spline at an inner surface configured to engage the at least one external spline of the inner shaft at a spline coupling. A channel is provided at the connection interface in at least one of the inner and outer shafts. A seal configured to be received at least partially within the channel defines a fluid passage, which his configured to meter a fluid to the spline coupling.

Another aspect of the disclosure provides a method of metering a lubricant to a splined coupling. The method includes providing a splined shaft assembly as described above, and providing a source of fluid to at least one side face of the seal.

Yet another aspect of the disclosure is to provide a seal for a splined shaft assembly. The seal can have a symmetrical, ring-shaped, rectangular cross-section body with a first side face, a second side face, an inner surface, an outer surface. The seal can have at least one fluid passage configured to meter a fluid at a defined rate to a spline coupling. The fluid passage can extend along the first side face only partially between the inner surface and the outer surface and along the inner surface only partially between the first and second side faces. The fluid passage can be positioned at an intersection of the inner surface and the first side face. Further, the fluid passage can form a concave surface that has a largest radial dimension at the intersection of the inner surface and the first side face.

These and other aspects and advantages of the improved spline coupling arrangement disclosed herein will become better understood upon consideration of the detailed description of the drawings.

### BRIEF DESCRIPTION OF THE DRAWINGS

FIG. 1 is a view of an example transmission including a splined shaft coupling in accordance with the present disclosure;

FIG. 2 is a cross-sectional view of the splined shaft coupling taken along line 2-2 of FIG. 1;

FIG. 3 is a partial perspective view of the splined shaft coupling of FIG. 2 in isolation;

FIG. 4 is an exploded view of the splined shaft coupling of FIG. 3;

FIG. 5 is a cross-sectional perspective view taken along line 5-5 of FIG. 3;

FIG. 6 is a plan view thereof;

FIG. 7 is an enlarged partial cross-sectional view as taken along arc 7-7 of FIG. 5;

FIG. 8 is a perspective view of a sealing ring for the splined shaft coupling of FIG. 3;

FIG. 9 is a plan view thereof;

FIG. 10 is a enlarged partial plan view of the sealing ring as taken along arc 10-10 of FIG. 9 showing a fluid passage;

FIG. 11 is a partial top view showing the fluid passage as viewed from line 11-11 of FIG. 10;

FIG. 12 is a partial cross-sectional view showing the fluid passage as taken along line 12-12 of FIG. 10; and

FIG. 13 is a cross-sectional view showing the sealing ring as viewed from line 13-13 of FIG. 9.

Like reference numerals will be used to refer to like parts from figure to figure in the following detailed description.

### DETAILED DESCRIPTION

As also discussed above, in various situations it may be useful to provide lubrication to a coupling between two rotary shafts, such as a splined shaft assembly. For example, it may be useful to meter a lubricant to be flushed through a spline coupling between two shaft members. In order to guide the flow path of the lubricant, a coupling between rotary shafts may be provided with one or more features including channels, ports, passages, conduits and so forth. However, the inclusion of such features may require additional machining steps that can increase manufacturing costs associated with the production of the coupling. Moreover, even if such features are provided, it may still be difficult to meter the lubricant or other fluid to the joint to achieve proper lubrication. In one aspect, under-lubrication may result in suboptimal operating conditions, whereas over-lubrication may increase operating costs and may result in wasted lubricant. Various other problems may also arise as requirements for lubrication become more exacting.

Use of the disclosed splined shaft coupling arrangement may address these and other issues. For example, for a spline coupling between an inner shaft with at least one external spline and an outer shaft, a channel may be disposed at the interface between the inner and outer shafts. A seal may be disposed in the channel, such that the geometry of the seal and the channel may cooperate to meter a fluid, such as a lubricant, across the spline coupling. The seal may further include a fluid passage to improve the metering of lubricant across the spline coupling.

A splined shaft coupling arrangement according to the present disclosure may be configured in any suitable shape and size to effectively meter lubricant to the spline coupling. For example, it may be useful to provide a channel and a seal with a generally rectangular cross-section, such as a square cross-section. In various embodiments, multiple seals may also be used with one or more seals positioned within a single channel. Alternatively (or in addition), more than one channel can be positioned at the interface between the inner and outer shafts with at least one seal positioned in each of the channels. Further, the multiple seals can have the same or different cross-sections and sizes.

The seals disclosed are shown and described as being associated with a rotary spline coupling, and thus caused to rotate or not rotate with the inner and outer shafts. However, the seals can be arranged to rotate independently of the inner and outer shafts. It will also be appreciated that embodiments of shaft couplings in which one or more splines are omitted may still have seals that are disposed at the interface between the shafts. Furthermore, although various examples herein may discuss the use of a seal with respect to a planetary gear arrangement, it will be understood that the principles of a seal for metering a lubricant may be usefully applied to various other mechanical arrangements as well, including various other transmission arrangements.

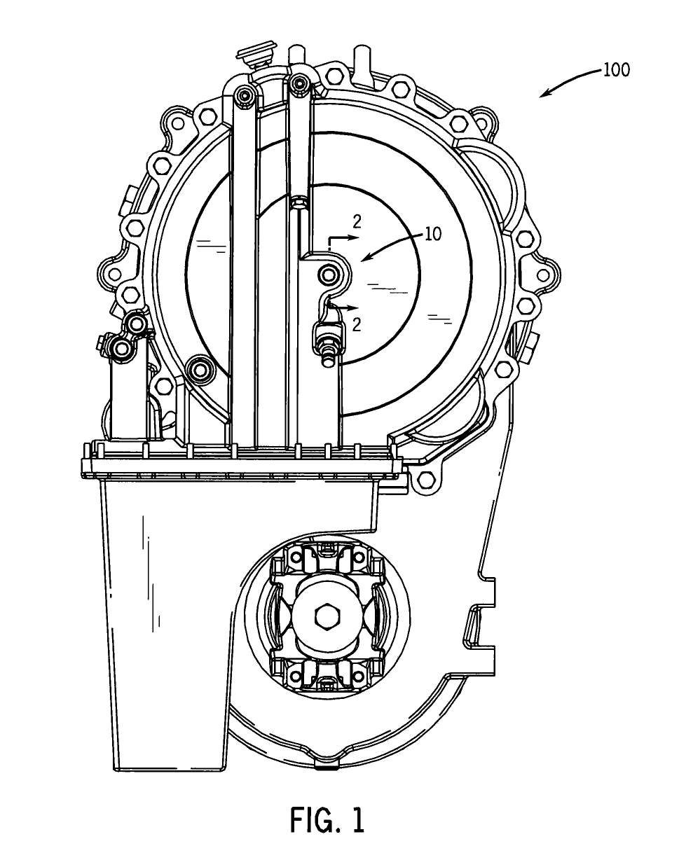

The system and method of the present disclosure can be understood with reference to the example shown in the drawings. Referring now to FIG. 1, an example embodiment of a drive shaft 10 of the present disclosure is illustrated in the context of a transmission 100 for a work vehicle (not shown). While a transmission 100 is shown in FIG. 1, it is to be understood that the drive shaft 10 is suitable for use in any system in which it is desirable to transmit torque. Moreover, the seals described in the present disclosure are useful not only for drive shafts such as drive shaft 10, but also for spline couplings in general.

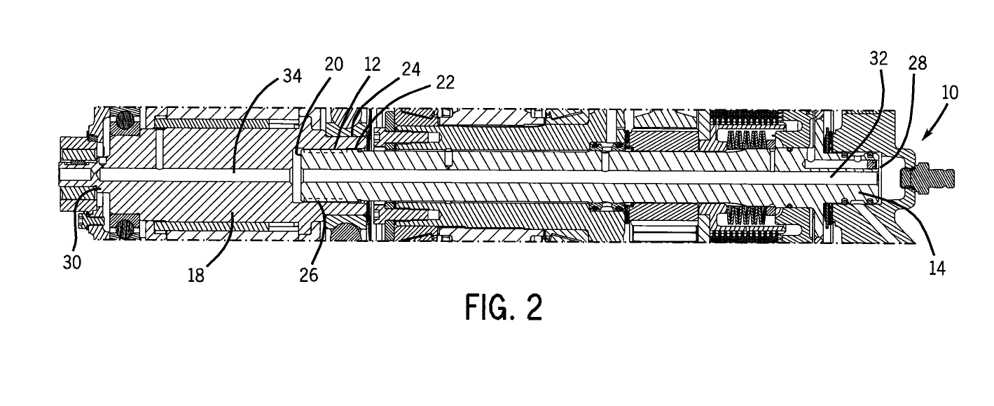

With reference to FIG. 2, the drive shaft 10 includes a spline coupling 12 formed at engaging splines of an inner shaft 14 and an outer shaft 18 and sealed at a connection interface of the inner 14 and outer 16 shafts by seal 16. A first end 20 of the inner shaft 14 includes a plurality of longitudinal ridges or external splines 22 spaced at regular intervals about an outer circumference of the inner shaft 14. In order to form a coaxial coupling with the inner shaft 14, the outer shaft 18 includes a first end 24 having an internal bore sized to receive at least a portion of the first end 20. The first end 24 includes a plurality of longitudinal ridges or internal splines 26 spaced at regular intervals about an inner circumference of the internal bore of the outer shaft 18. The internal splines 26 are sized and positioned to complement and mate with the external splines 22 in order to effectively transmit torque between the inner shaft 14 and outer shaft 18.

Whereas the inner shaft 14 includes external splines 22 that extend only partway from the first end 20 along the length of the inner shaft 14, it is possible to include external splines 22 elsewhere along the length of the inner shaft 14. For example, the inner shaft 14 can include external splines 22 on a second end 28 opposing the first end 20, at intermediate locations, or along the entire length of the inner shaft 14. As with the inner shaft 14, it is possible to include internal splines 26 elsewhere on the outer shaft 18. For example, the outer shaft 18 can include an internal bore with internal splines on a second end 30 opposing the first end 24, at intermediate locations, or along the entire length of the outer shaft 18. Furthermore, any number or type of splines or similar interior or external features for mating with another shaft can be used to in the implementation of the system and methods of the present disclosure.

The drive shaft 10 can also include additional features or assume alternate configurations as necessary to accommodate the specific system into which the drive shaft 10 is incorporated. In the example shown in FIG. 1, the inner shaft 14 includes an internal axial passage 32 and outer shaft 18 includes an internal axial passage 34. Internal axial passages 32 and 34 are in fluid communication with each other as well as with a source of lubricant to supply the lubricant to the spline coupling 12. Inner shaft 14 and outer shaft 18 can also include further passages for routing lubricants or other fluids and can have configurations to couple to and transmit or receive energy from other components in the system.

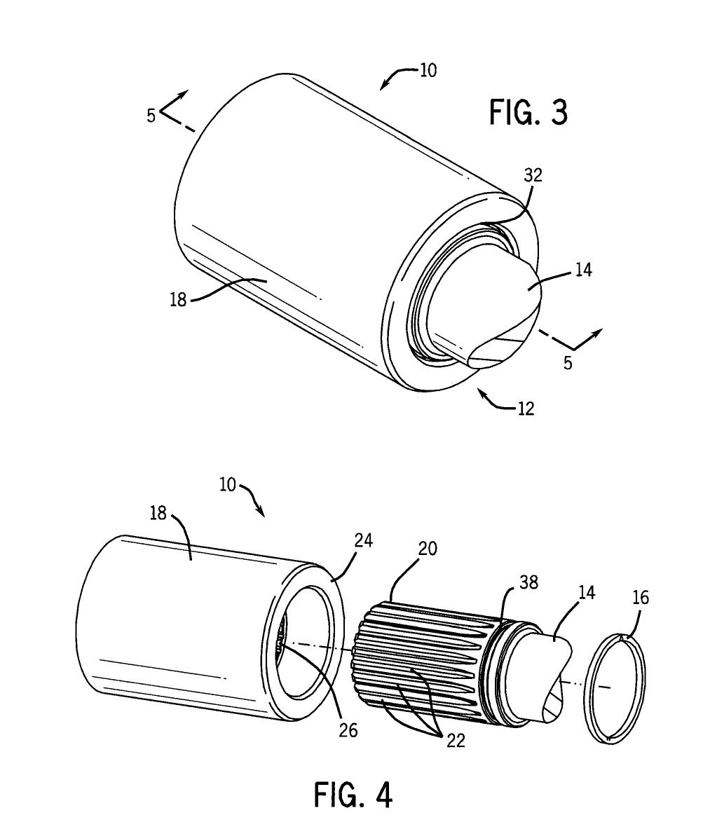

Turning now to FIGS. 3 and 4, it can be seen that the outer diameter of the inner shaft 14 (excluding the external splines 22) is smaller than the inner diameter of the internal bore of the outer shaft 18 (excluding the internal splines). As a result, a portion of the seal 16 is visible near the interface between the inner shaft 14 and the outer shaft 18. The inner shaft 14, seal 16 and outer shaft 18 are coaxially positioned about a longitudinal axis of rotation of the drive shaft 10. FIG. 4 illustrates the seal 16 as having a generally symmetrical ring-shape. The ring-shaped seal 16 can also include one or more features such as a notch, passage, groove, projection and the like. In the example embodiment, the seal 16 includes a fluid passage 36 in the form of a notched edge (see FIGS. 8-13). In one aspect, the fluid passage 36 is configured and sized to meter one or more fluids, such as a lubricant, across the seal 16.

The seal 16 is sized to occupy a circumferential channel 38 formed inward from the external splines 22 along the length of the inner shaft 14. In the present embodiment of the drive shaft 10, the external splines 22 are provided by forming a number of parallel grooves in the outer surface of the inner shaft 14. The grooves extend in a longitudinal direction from the first end 20 and taper off as the grooves approach the channel 38 until the external splines 22 are flush with the outer surface of the inner shaft 14. Thus, the external splines 22 terminate prior before reaching channel 38.

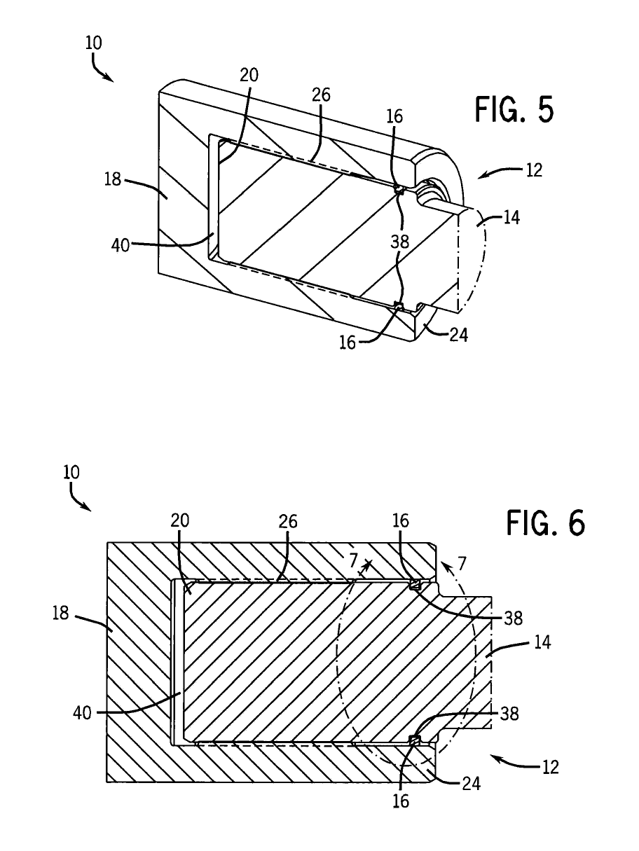

FIGS. 5 and 6 highlight the spline coupling 12 and in particular, the interface between the inner shaft 14 and outer shaft 18. The location of the seal 16 relative to the inner and outer shafts 14, 16 is also illustrated. In the illustrated example, the channel 38 is located proximal to the first end 24 of the outer shaft 18. The seal 16 resides in a cavity defined by the internal bore of the outer shaft 18 and the channel 38 in the inner shaft 14. It can be seen from FIGS. 5 and 6 that the external splines 22 and the internal splines 26 form a close coupling. However, the end face of the first end 20 of the inner shaft 14 does not necessarily contact an interior surface of the outer shaft 18. As a result, there exists a space 40 between end face of the first end 20 of the inner shaft 14 and the interior surface of the outer shaft 18.

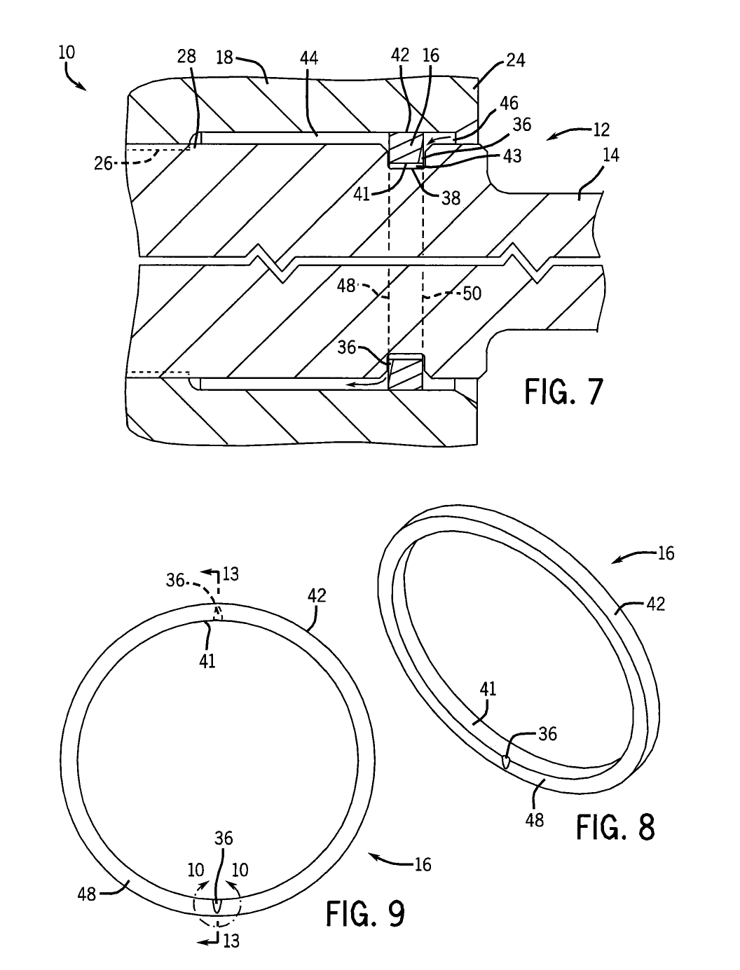

Also referring to FIG. 7, the seal 16 is shown as having a generally square cross-section with a width dimension in a direction parallel to the axial direction of the drive shaft 10 and a perpendicular height dimension in the radial direction. The width of the seal is sized to be generally equivalent to the width of the channel 38. However, the height of the seal 16, while generally greater than the depth of the channel 38, has a dimension which is generally less than the height of the cavity as defined by the depth of the channel 38 and the internal bore of the outer shaft 18. More particularly, for a seal 16 with a circular or ring-shaped construction, the seal 16 may have an inner surface 41 and an outer surface 42. The inner surface 41 corresponds with an inner diameter of the seal 16, while the outer surface 42 corresponds with an outer diameter of the seal 16.

In the illustrated example, the outer surface 42 of the seal 16 is dimensioned such that the seal 16 is in contact with the internal bore of the outer shaft 18. However, the inner surface 41 of the seal is sized to space the seal 16 apart from the base of the channel 38, thereby providing a gap 43 between the inner surface 41 and the base of the channel 38. The lack of space between the outer surface 42 and the outer shaft 18 or the gap 43 between the inner surface 41 and the inner shaft 14 may provide control over the rate at which a lubricant or other fluid is metered to the spline coupling. It can also be seen from FIG. 7 that space between the internal bore of the outer shaft 18 and the outer surface of the inner shaft 14 defines a proximal cavity 44 and a distal cavity 46 on either side of the seal along the longitudinal axis of the drive shaft 10. The proximal cavity 44 is positioned closer to the end face of the first end 20, whereas the distal cavity 46 is positioned on the other side of the seal 16, away from the end face of the first end 20 and closer to the first end 24 of the outer shaft 18.

FIGS. 8-13 detail the location and dimension of two fluid passages 36. While the fluid passages 36 can encompass a number of shapes and sizes, in the illustrated example, the fluid passages 36 define a concave recessed area generally corresponding to a somewhat oblong quarter hemisphere. A first fluid passage 36 is positioned at the intersection of the inner surface 41 and a first side face 48 of the seal 16. A second fluid passage 36 is positioned at the intersection of the inner surface 41 and a second side face 50, which is opposite the first side face 48. The fluid passages 36 may be positioned 180 degrees apart around the circumference of the ring-shaped seal 16 as shown at least in FIG. 13. However, the fluid passages 36 may also be positioned at other relative angles. In one example, a first fluid passage 36 is positioned at about 180 degrees±about 30 degrees from a second fluid passage 36. Moreover, the fluid passages 36 may be positioned in the same face of the seal 16, such as in the first side face 48, as opposed to being positioned in opposite faces of the seal 16 as illustrated in the drawings. Alternatively (or in addition), the number of fluid passages 36 formed in the a seal 16 may vary. For example, in some embodiments, only one fluid passage 36 may be used, whereas in other embodiments, three or more fluid passages 36 may be used. When multiple fluid passages 36 are used, the fluid passages 36 may be positioned in any number of spatial relationships. For example, the fluid passages 36 may be equally spaced about a circumference of the seal 16 or they may be irregularly spaced.

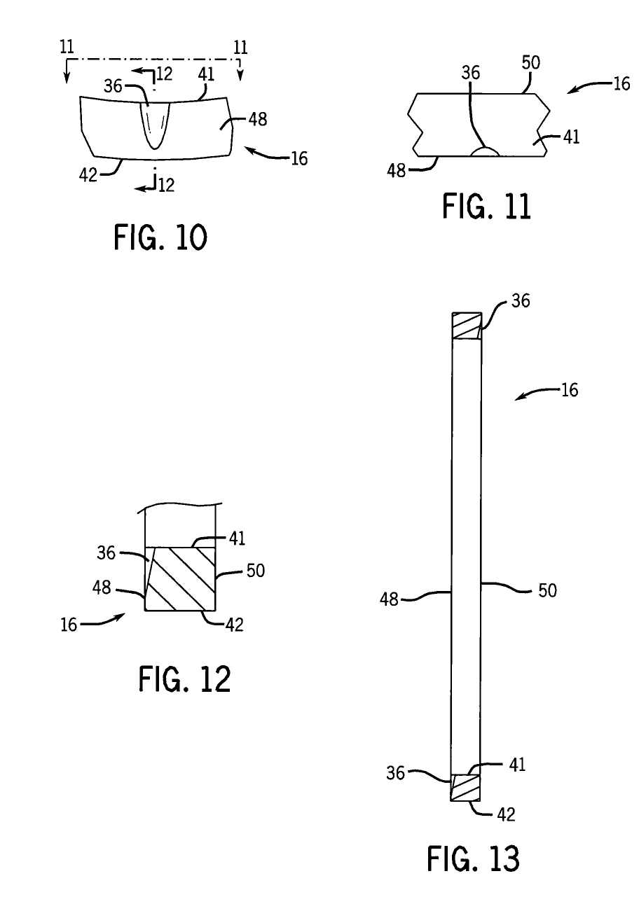

As illustrated in FIGS. 10 and 12-13, the first fluid passage 36 extends across the first side face 48 of the seal 16, although the dimension of the fluid passage 36 in this direction is slightly less than distance between the inner surface 41 and the outer surface 42 of the seal 16. As shown in FIGS. 11-13, the depth to which the first fluid passage 36 extends into the seal 16 in the longitudinal/width dimension is less than the width of inner surface 41 between the first 48 and second 50 side faces of the seal 16. When the seal 16 is positioned in the channel 38, the fluid passages 36 may be open to a side wall of the channel 38 and the outer surface of the inner shaft 14 (i.e., the base of the channel 38). In one aspect, the fluid passage 36 may be in fluid communication with the gap 43. Moreover, depending on the orientation of the seal 16, the fluid passages 36 may be in fluid communication with either the proximal cavity 44 or the distal cavity 46. As the fluid passage 36 may only partially extend from the inner surface 41 toward the outer surface 42 of the seal 16, the fluid passage 36 may not be open to the inner surface of the outer shaft 18. Therefore, in the illustrated embodiment, the fluid passage 36 may enable the metering of a fluid such that the fluid passes preferably between the inner surface 41 of the seal 16 and the inner shaft 14 as compared with a flow path between the outer surface 42 of the seal 16 and the outer shaft 18.

Referring to FIG. 7, the chamfered edges of the channel 38 provide that the fluid passages 36 are at least partially open to proximal 44 and distal 46 cavities. One example flow path illustrated in FIG. 7 is indicated by the arrows drawn in the proximal 44 and distal 46 cavities. In one aspect, a fluid can pass from the distal cavity 46 through a fluid passage 36 in the second side face 50. The fluid can then pass to the channel 38 and more particularly, the gap 43 between the base of the channel 38 and the inner surface 41. While in the gap 43, the fluid can travel around the circumference of the inner shaft 14 via the channel 38. When the fluid has passed about 180 degrees around the circumference of the channel 38, the fluid can travel through the fluid passage 36 in the first side face 48, which opens at least partially to the proximal cavity 44. The fluid may then be provided to the spline coupling 12. It will be appreciated that the example flow path described may be one of a number of possible flow paths, and that alternative flow paths are within the scope of the present disclosure. For example, the illustrate flow path may be reversed such that fluid may pass from the proximal cavity 44, through the fluid passages 36 in the first 48 and second 50 side faces and into distal cavity 46.

As an alternative (or addition) to fluid passages 36 illustrated in the drawings, in other embodiments, one or more of the fluid passages 36 may fully extend between the first side face 48 and second side face 50. In one aspect, the fluid passages 36 may be formed in the inner surface 41, the outer surface 42 or between the inner 41 and outer 42 surfaces. In yet another aspect, the seal 16 may include a longitudinal split such that the seal 16 forms a discontinuous ring with one or more radial breaks.

In operation of the drive shaft 10, the spline coupling 12, and in particular the external 22 and internal splines 26 provide a secure mating connection between the inner shaft 14 and the outer shaft 18. Therefore, application of a torque to one of the inner shaft 14 and outer shaft 18 results in the transfer of said torque to the other of the inner shaft 14 and outer shaft 18. The seal 16 positioned in the channel 38 provides a fluid barrier between the areas that are interior and exterior to the first end 24 of the outer shaft (i.e., the spline coupling 12). However, fluid passage 36 enables the controlled metering of fluid across the seal 16. For example, if it is desirable to provide lubrication to the spline coupling 12 during operation of the drive shaft 10, a lubricant can be passed between proximal cavity 44 and distal cavity 46 by way of one or more of fluid passage 36 and gap 43. As proximal cavity 44 and the interface between internal 26 and external 22 splines are in fluid communication, lubricant can be effectively metered to or from the spline coupling 12. Alternatively, or in addition, lubricant can pass from the interface between internal 26 and external 22 splines to the space 40. Furthermore, passages in fluid communication with space 40 can be provided as shown in FIG. 2 to further route the lubricant.

While the present disclosure has described the spline coupling and seal in terms of one particular embodiment, it is possible the components of the drive shaft can have other configurations which fall within the scope of the present disclosure. For example, the channel can be positioned at alternative locations on either of the inner shaft and/or outer shaft of the drive shaft assembly. In one aspect, the channel can be positioned intermediate the length of splines. In another aspect, the spline coupling can be sealed by multiple seals positioned in one or more channels. Moreover, the one or more seals can include more than one feature such as fluid passage. For example, an individual seal can have multiple fluid passages of varying shapes and sizes in order to achieve the desired fluid metering arrangement.

The description of the present disclosure has thus been presented for purposes of illustration and description, but is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Accordingly, various embodiments and implementations other than those explicitly described are within the scope of the following claims.

What is claimed is:

1. A splined shaft assembly, comprising:
an inner shaft having at least one external spline at an outer surface;
an outer shaft having an internal cavity configured to receive and mate with the inner shaft at a connection interface, the outer shaft having at least one internal spline at an inner surface configured to engage the at least one external spline of the inner shaft at a spline coupling;
a channel in at least one of the inner and outer shafts and positioned at the connection interface; and
a seal configured to be received at least partially within the channel, the seal defining a fluid passage configured to meter a fluid to the spline coupling.

2. The splined shaft assembly of claim 1, wherein the seal has an inner surface, an outer surface, a first side face and a second side face.

3. The splined shaft assembly of claim 2, wherein the fluid passage is positioned at an intersection of the inner surface and the first side face.

4. The splined shaft assembly of claim 3, wherein the fluid passage extends along the inner surface only partially between the first and second side faces.

5. The splined shaft assembly of claim 3, wherein the fluid passage extends along the first side face only partially between the inner and outer surfaces.

6. The splined shaft assembly of claim 1, wherein the channel has a rectangular cross-section, and wherein the seal has a rectangular cross-section.

7. The splined shaft assembly of claim 5, wherein an inner diameter of the seal is greater than an inner diameter of the channel such that there is a gap formed between the inner surface of the seal and the channel.

8. A method of metering a lubricant to a splined coupling, comprising the steps of:
providing a splined shaft assembly comprising:
an inner shaft having at least one external spline;
an outer shaft having an internal cavity configured to receive and mate with the inner shaft at a connection interface, the outer shaft having at least one internal spline at an inner surface configured to engage the at least one external spline of the inner shaft at a spline coupling; and
a channel in at least one of the inner and outer shafts and positioned at the connection interface;
positioning a seal in the channel, the seal having fluid passage configured to meter fluid to the spline coupling at a predetermined rate; and
providing a source of fluid to at least one side face of the seal.

9. The method of claim 8, wherein the seal is a symmetrical, ring-shaped seal having an inner surface and an outer surface and first and second side faces.

10. The method of claim 9, wherein the fluid passage extends along the inner surface only partially between the first and second side faces.

11. The method of claim 9, wherein the fluid passage extends along the first side face only partially between the inner and outer surfaces.

12. The method of claim 9, wherein the fluid passage is positioned at an intersection of the inner surface and the first side face.

13. The method of claim 8, wherein the area defined by the channel has a rectangular cross-section, and wherein the seal has a rectangular cross-section.

14. The method of claim 12, wherein an inner diameter of the seal is greater than an inner diameter of the channel such that there is a gap formed between the inner surface of the seal and the channel.

15. A seal for a splined shaft assembly, comprising a symmetrical, ring-shaped structure having a first side face, a second side face, an inner surface, an outer surface, and a rectangular cross-section,
wherein the seal has at least one fluid passage and is configured to meter a fluid at a defined rate to a spline coupling.

16. The seal of claim 15, wherein the fluid passage extends along the first side face only partially between the inner surface and the outer surface.

17. The seal of claim 16, wherein the fluid passage extends along the inner surface only partially between the first and second side faces.

18. The seal of claim 17, wherein the fluid passage is positioned at an intersection of the inner surface and the first side face.

19. The seal of claim 17, wherein the fluid passage is forms a concave surface that has a largest radial dimension at the intersection of the inner surface and the first side face.

20. The seal of claim 15, wherein the seal has a square cross-section.
